(19) United States
(12) Patent Application Publication
(10) Pub. No.: US 2025/0052328 A1
(43) Pub. Date: Feb. 13, 2025

(54) Oil Drain Apparatus

(71) Applicant: James D. Bower, Bradenton, FL (US)

(72) Inventor: James D. Bower, Bradenton, FL (US)

(21) Appl. No.: 18/446,329

(22) Filed: Aug. 8, 2023

(51) Int. Cl. F16K 5/06; F16L 15/00; F16L 15/04

(52) U.S. Cl. CPC F16K 5/0647; F16L 15/006; F16L 15/04

(57) ABSTRACT

An oil drain apparatus comprises a plurality of fittings, a plurality of tubing sections, and a valve. The oil drain apparatus may further include a washer and a removable cap, thus limiting the amount of oil spilled. A first threaded fitting screws into the oil pan of a vehicle and oil is then enabled to travel the length of the sections of tubing to a containing vessel. The valve enables a user to prevent unintentional oil spillage. The removeable cap screws onto one end of the apparatus to prevent leaking from the tubing. The apparatus may be coiled and secured to the underside of the vehicle during operation of the vehicle.

### FIELD OF THE INVENTION

The present invention relates generally to equipment for motor vehicle maintenance. More specifically, the present invention is an apparatus to assist users in changing the engine oil of their vehicle.

### BACKGROUND OF THE INVENTION

Changing engine oil is a critical aspect of vehicle maintenance, aimed at ensuring optimal engine performance and prolonging engine life. The process involves the removal of old, used oil from the engine, which is then replaced with fresh, clean oil.

Engine oil plays a crucial role in lubricating various engine components, reducing friction and wear between moving parts. Over time, the oil deteriorates and becomes contaminated with dirt, debris, and harmful substances from the engine's combustion process. This degradation reduces its lubricating effectiveness, compromising engine efficiency and potentially leading to costly engine damage.

To maintain engine health and prevent significant mechanical issues, regular oil changes are essential. Adhering to the manufacturer-recommended oil change intervals ensures that the engine continues to operate smoothly and efficiently. When changing ones oil, also referred to as engine oil, a user must drain the a reservoir beneath the engine that collects and holds the engine oil referred to as an oil via the drain plug. The drain plug is a screw-like component at the bottom of the oil pan used to drain the used oil during an oil change.

During traditional oil changes, a common issue is the potential for oil spillage, leading to safety hazards and environmental pollution. The prior art has been plagued by significant shortcomings that have hindered the effectiveness and user experience of oil changing procedures. Conventional oil draining methods have relied on unscrewing the oil pan's drain plug, leading to uncontrolled oil flow and frequent spills. This lack of control poses safety risks and results in environmental pollution due to the improper handling of used oil. Moreover, the absence of a secure and organized system for oil disposal further complicates the process, often leading to inconvenience and mess.

Existing oil drain apparatuses have attempted to address these issues, but many have fallen short. Some have complex designs, making installation and operation cumbersome for users. Others lack an efficient means of securing the tubing system to the vehicle, leading to potential damage during operation. Additionally, certain solutions lack a convenient way to close the tubing system, leading to oil leakage and requiring additional clean-up efforts.

Overall, the prior art has struggled to provide a simple, efficient, and environmentally conscious solution to the challenges associated with changing vehicle oil. The major shortcomings include uncontrolled oil flow, lack of spill prevention, and inadequate means of securing the apparatus during use. As a result, there has been a pressing need for a more effective and user-friendly oil drain apparatus, which the present invention aims to fulfill. The present invention offers a solution by incorporating various components that work in conjunction to optimize the oil changing process. The key components of the apparatus include a threaded fitting, a washer, tubing sections, a turn valve, a discharge fitting, and a removable cap. The threaded fitting serves as the primary attachment point, securely screwing into the oil pan of the car. To ensure a tight seal and prevent leaks, a washer is positioned between the threaded fitting and the oil pan. The tubing sections are vital for transporting the used oil from the oil pan to the discharge fitting. The first section of tubing is attached to the threaded fitting at one end and connected to the intake port of the turn valve at the other end. The turn valve plays a crucial role in controlling the oil flow, allowing users to adjust and regulate the flow rate, thereby minimizing the risk of spillage during the process. From the exit port of the turn valve, the second section of tubing transports the used oil to the discharge fitting. The discharge fitting is responsible for directing the used oil into a container for proper disposal or recycling, contributing to the environmental friendliness of the invention. Furthermore, the apparatus features a removable cap that can be screwed onto the discharge fitting's threaded end. This cap serves as a sealing mechanism when the apparatus is not in use, preventing oil leakage and keeping the system tidy and organized.

The present invention's objectives are to provide a simple, effective, and environmentally friendly oil drain apparatus that reduces oil spillage during the oil change process. By achieving these objectives, the invention aims to enhance the overall oil changing experience for users, promoting regular vehicle maintenance and extending the engine's performance and lifespan.

### SUMMARY OF THE INVENTION

The oil drain apparatus is a new and improved way to change the oil in vehicles, making the process cleaner and simpler. The oil drain apparatus includes various parts that work together to achieve this goal including a first threaded fitting, a washer, a plurality of tubing sections, a turn valve, a discharge fitting, and a removable cap. The first threaded fitting, which includes a washer, screws tightly into the car's oil pan, ensuring no oil spills during use of the apparatus. The multiple sections of tubing transport oil from the oil pan to a containment vessel. The turn valve helps control the flow of oil, allowing users to restrict flow of oil at any time. The discharge fitting allows for users to screw a removeable cap to seal the apparatus from leaking.

### BRIEF DESCRIPTION OF THE DRAWINGS

FIG. 1 is a front view of the present invention having two separate breaks in the figure.

FIG. 2 is a perspective view of the first fitting of the present invention.

FIG. 3 is a front view of the valve of the present invention with hidden lines showing the internal mechanism of the valve.

FIG. 4 is a perspective view of the washer of the present invention.

FIG. 5 is a perspective view of the second fitting of the present invention.

FIG. 6 is a front view of an alternate embodiment of the present invention having two separate breaks in the figure.

FIG. 7 is a perspective view of an alternate embodiment of the first fitting of the present invention.

FIG. 8 is a side view of the present invention in a coiled configuration.

FIG. 9 is a perspective view of the present invention secured to the oil pan of a vehicle.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of an oil drain apparatus, embodiments of the present disclosure are not limited to use only in this context. Within the context of the present invention, and as is well understood to one skilled in the art, a tube, including tubing, is a hollow cylinder for transporting fluids.

Furthermore, a fitting and a valve, as is known and well understood within the art, are devices that allow for flow of fluid through said devices. Additionally, a cap, as used within the context of the present invention, synonymous with the term “lid,” is a device intended to cover an opening.

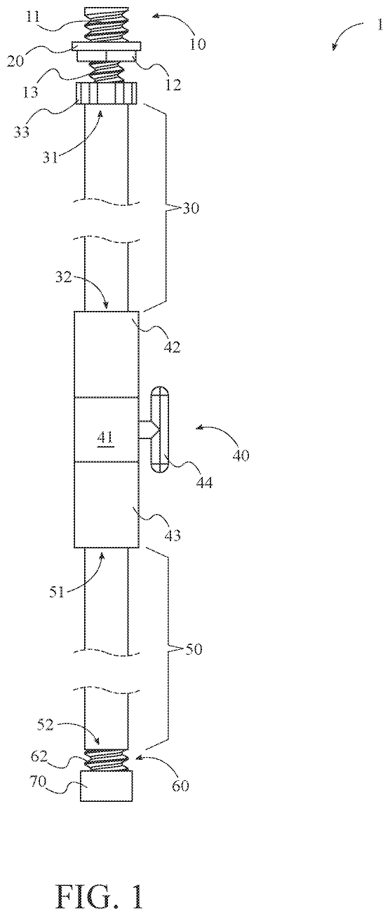

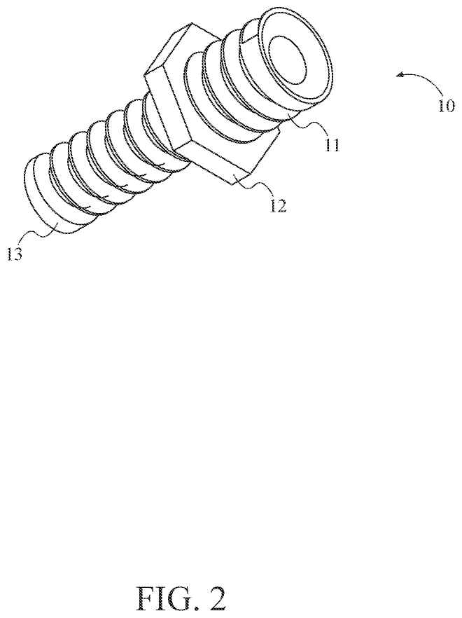

FIGS. 1-9, as shown and described herein, are representative of the present invention. As shown in FIG. 1, the present invention is an oil drain apparatus 1 comprising a plurality of fittings 10, 60, a plurality of sections of tubing 30, 50, and a valve 40. In the preferred embodiment the present invention comprises a first fitting 10 and a second fitting 60. Furthermore, in the preferred embodiment of the present invention, the plurality of sections of tubing 30, 50 comprises a first section of tubing 30 and a second section of tubing 50. The first section of tubing 30 comprises a first end 31 and a second end 32. Likewise, the second section of tubing 50 comprises a first end 51 and a second end 52. The valve 40 comprises an inlet port 42 and an outlet port 43. In the preferred embodiment of the present invention, as shown in FIG. 1 and FIG. 2, the first fitting 10 is connected to the first end 31 of the first section of tubing 30, the second end 32 of the first section of tubing 30 is coupled to the inlet port 42 of the valve 40, and the outlet port 43 of the valve 40 is coupled to the first end 51 of the second section of tubing 50. In some embodiments of the present invention the first end 31 of the first section of tubing 30 comprises a collar 33 wherein said collar is a female threaded fitting to secure the first fitting 10 to the first section of tubing 30.

In the preferred embodiment of the present invention, the first fitting 10, as shown in FIG. 2, comprises a first threaded fitting 11, a hexagonal cross section 12, and a second threaded fitting 13. In the preferred embodiment, the first threaded fitting 11 is adjacent to the hexagonal cross section 12, wherein the hexagonal cross section 12 is adjacent to the second threaded fitting 13. In the preferred embodiment of the present invention, the hexagonal cross section 12 is located approximately medially on the first fitting 10 and enables a user to tighten and loosen the first fitting 10. Further, in the preferred embodiment of the present invention, the second threaded fitting 13 is inserted into the first end 31 of the first section of tubing 30, thus leaving the first threaded fitting 11 exposed. In some embodiments, the second threaded fitting 13 screws into the collar 33.

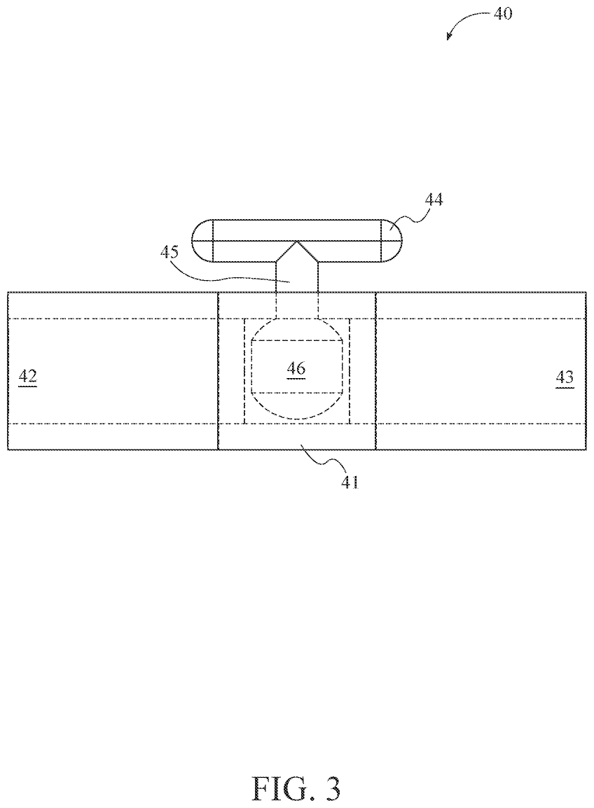

In the preferred embodiment of the present invention, the valve 40, as shown in FIG. 3, comprises a housing 41 wherein said housing 41 comprises the inlet port 42 and the outlet port 43. The inlet port 42 and the outlet port 43 are connected via a channel through the housing 41, as is understood within the art. Furthermore, the valve 40 comprises a handle 44 wherein said handle 44 comprises a stem 45 and a plug 46. The handle 44 is connected to the plug 46 by way of the stem 45. The plug 46 is housed within the housing 41 of the valve 40 whereby the stem 45 extends outside of the housing 41. Turning of the handle 44 varies the positioning of the plug 46, thus varying the volumetric flow rate of fluid flowing through the valve 40. In the preferred embodiment of the present invention, the handle 44 enables the user to control the flow of the fluid through the apparatus.

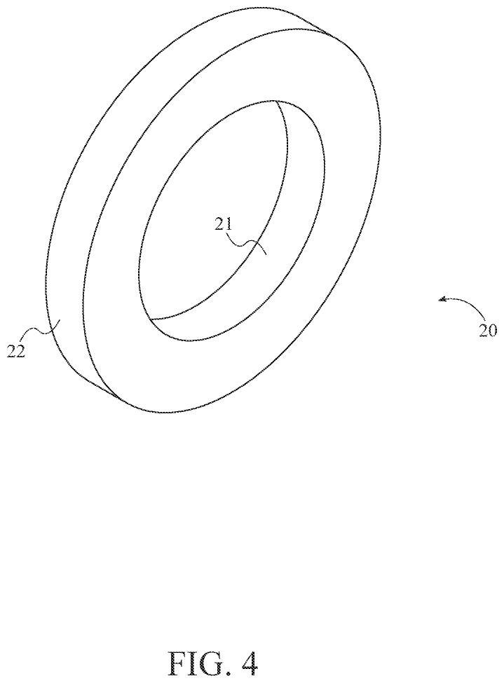

In some embodiments of the present invention, the present invention may further comprise a washer 20, as shown in FIG. 1 and FIG. 4. In the embodiments of the present invention wherein the oil drain apparatus 1 comprises the washer 20, the washer 20 is a circular disk comprises an interior circumference 21s and an outer circumference 22. In the aforementioned embodiment, the interior circumference 21 of the washer 20 is coaxially positioned around the first threaded fitting 11 of the first fitting 10 and engaging with the hexagonal cross section 12.

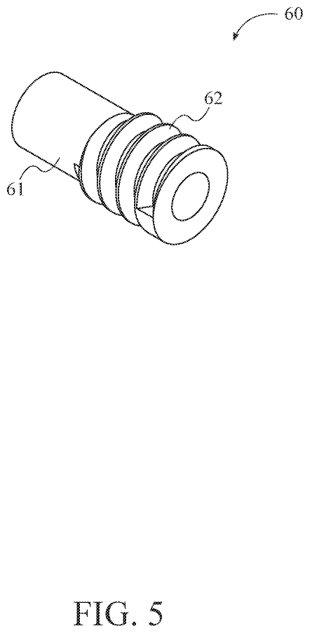

Furthermore, as shown in FIG. 1 and FIG. 5, in some embodiments of the present invention, the oil drain apparatus 1 further comprises a second fitting 60. The second fitting 60, in the aforementioned embodiments, comprises a press fitting 61 and a threaded fitting 62. In the preferred embodiments of the present invention, the second fitting 60 is connected to the second end 52 of the second section of tubing 50 wherein the threaded fitting 62 is accessible to the user. Furthermore, in some embodiments, the press fitting 61 of the second fitting 60 is inserted into the second end 52 of the second section of tubing 50.

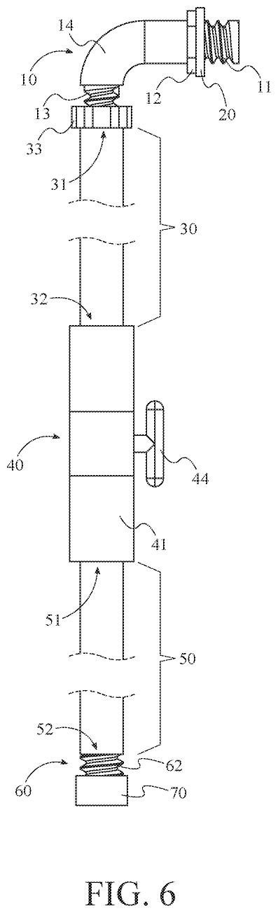

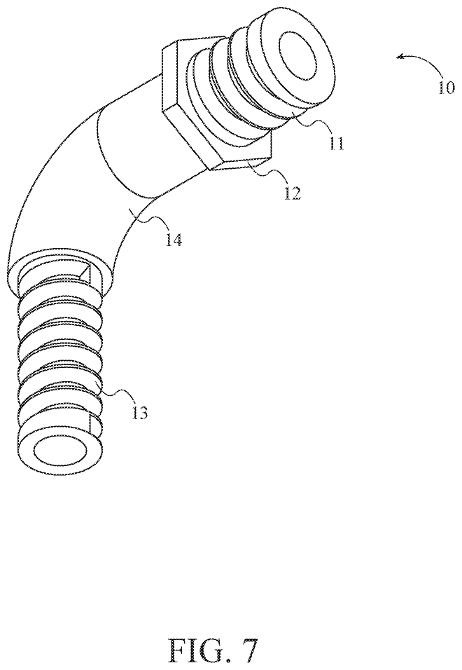

In some embodiments of the present invention, as shown in FIG. 6 and FIG. 7, the first fitting 10 further comprises a 90° angle 14. In the aforementioned embodiment of the present invention, the 90° angle 14 is at a proximal location between the second threaded fitting 13 and the hexagonal cross section 12.

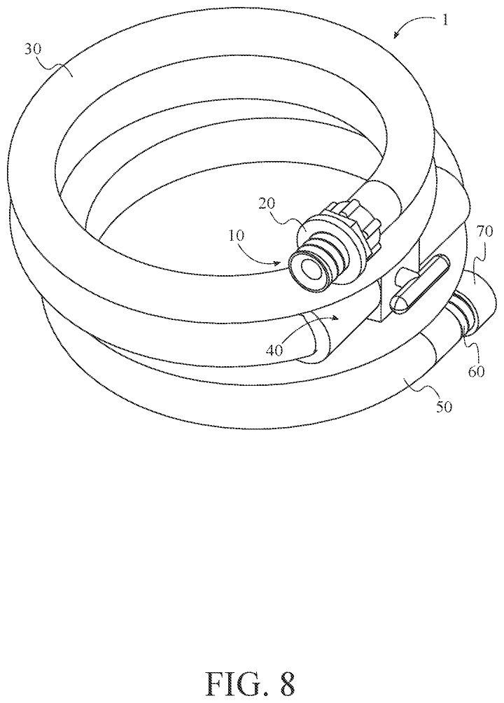

In the preferred embodiment of the present invention, the plurality of sections of tubing 30, 50 are composed of a flexible, heat resistant material such as a braided stainless steel tubing. In the preferred embodiment of the present invention, the plurality of sections of tubing 30, 50 is able to be coiled, as shown in FIG. 8. Furthermore, as shown in FIG. 1 and FIG. 8, in some embodiments of the present invention, the oil drain apparatus 1 further comprises a removeable cap 70. In the preferred embodiment wherein the present invention comprises a removeable cap 70, the cap 70 secures to the threaded fitting 62 of the second fitting 60.

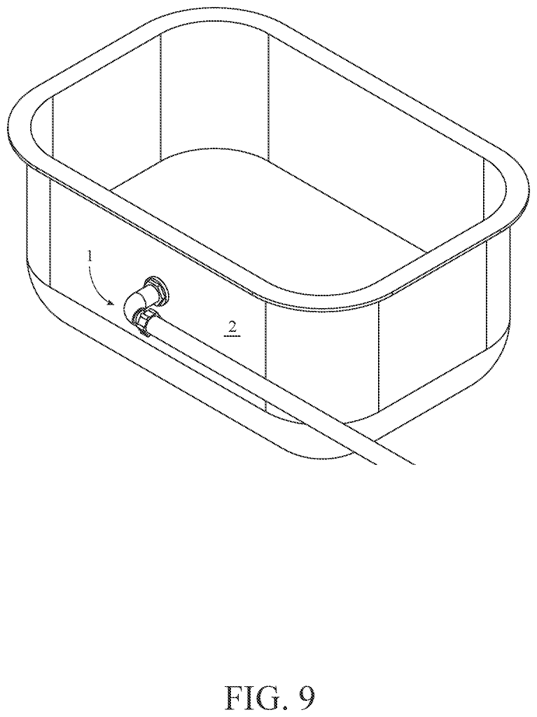

In the preferred embodiment of the present invention, the first threaded fitting 11 of the first fitting 10 screws into a drain plug hole of an oil pan 2, as shown in FIG. 9. In the aforementioned embodiment, the first fitting 10 is threaded into the oil pan 2, thus sealing the drain plug hole by compressing the washer 20 between the hexagonal cross section 12 of the first fitting 10 and the oil pan 2. The hexagonal fitting enables the user to tighten and loosen the fitting into the drain plug hole. Further, in the preferred embodiment, the oil drain apparatus 1 remains attached the oil pan 2 of the vehicle while the vehicle is in operation. While the vehicle is operation, in the preferred embodiment, oil drain apparatus 1 in configured into the coiled configuration and secured to the underside of the vehicle. To prevent oil from draining during operation of the vehicle, in this embodiment, the oil drain apparatus 1 comprises the cap 70. In the preferred embodiment, the means for securing the oil drain apparatus 1 to the underside of the vehicle includes a magnet, a clamp, a clip, or a securement device of the like.

Although the invention has been explained in relation to its preferred embodiment, it is to be understood that many other possible modifications and variations can be made without departing from the spirit and scope of the invention.

What is claimed is:

1. An oil drain apparatus comprising:
a first fitting;
a plurality of sections of tubing; and
a valve;
the plurality of sections of tubing comprising a first section of tubing and a second section of tubing;
the first section of tubing comprising a first end and a second end, wherein said first end and said second end are opposite distal ends of the first section of tubing;
the second section of tubing comprising a first end and a second end, wherein said first end and said second end are opposite distal ends of the second section of tubing;
the valve comprising a housing wherein said housing comprises an inlet port and an outlet port;
the first fitting connecting to the first end of the first section of tubing;
the second end of the first section of tubing connecting to the inlet port of the valve; and
the outlet port of the valve being connected to the first end of the second section of tubing.

2. The oil drain apparatus as claimed in claim 1 further comprising a second fitting wherein said second fitting is connected to the second end of the second section of tubing.

3. The oil drain apparatus as claimed in claim 1 wherein the first fitting comprises a first threaded fitting, wherein the first threaded fitting extends distally from the first end of the first section of tubing.

4. The oil drain apparatus as claimed in claim 1 wherein the valve further comprises a handle wherein the handle comprises a stem and a plug;
the handle connecting to the stem;
the stem connecting the plug;
the handle and the plug are positioned on opposite sides of the stem;
plug being housed within the valve; and
the handle is able to be adjusted to vary the volumetric flow rate of a fluid flowing through the valve.

5. The oil drain apparatus as claimed in claim 3 wherein the first fitting further comprises a hexagonal cross section adjacent to the first threaded fitting of the first fitting.

6. The oil drain apparatus as claimed in claim 2 wherein the second fitting further comprises a threaded fitting wherein said threaded fitting extends distally from the second end of the second section of tubing.

7. The oil drain apparatus as claimed in claim 6 further comprising a cap wherein said cap is removably attached to the threaded fitting of the second fitting.

8. The oil drain apparatus as claimed in claim 5 wherein the first threaded fitting of the first fitting screws into an oil pan of a vehicle.

9. The oil drain apparatus as claimed in claim 8 further comprising a washer;
the washer comprising an interior circumference and an outer circumference; and
the washer being positioned coaxially on the first threaded fitting of the first fitting, located between the oil pan and the hexagonal cross section.

10. An oil drain apparatus comprising:
a first fitting;
a plurality of sections of tubing; and
a valve;
the plurality of sections of tubing comprising a first section of tubing and a second section of tubing;
the first section of tubing comprising a first end and a second end, wherein said first end and said second end are opposite distal ends of the first section of tubing;
the second section of tubing comprising a first end and a second end, wherein said first end and said second end are opposite distal ends of the second section of tubing;
the valve comprising a housing wherein said housing comprises an inlet port and an outlet port;
the first fitting comprising a 90° angle;
the first fitting connecting to the first end of the first section of tubing whereby the fitting extends normally from the first section of tubing;
the second end of the first section of tubing connecting to the inlet port of the valve; and
the outlet port of the valve being connected to the first end of the second section of tubing.

11. The oil drain apparatus as claimed in claim 10 further comprising a second fitting wherein said second fitting is connected to the second end of the second section of tubing.

12. The oil drain apparatus as claimed in claim 10 wherein the first fitting comprises a first threaded fitting, wherein the first threaded fitting extends distally from the first end of the first section of tubing.

13. The oil drain apparatus as claimed in claim 10 wherein the valve further comprises a handle wherein the handle comprises a stem and a plug;
the handle connecting to the stem;
the stem connecting the plug;
the handle and the plug are positioned on opposite sides of the stem;
plug being housed within the valve; and
the handle is able to be adjusted to vary the volumetric flow rate of a fluid flowing through the valve.

14. The oil drain apparatus as claimed in claim 12 wherein the first fitting further comprises a hexagonal cross section adjacent to the first threaded fitting of the first fitting.

15. The oil drain apparatus as claimed in claim 11 wherein the second fitting further comprises a threaded fitting wherein said threaded fitting extends distally from the second end of the second section of tubing.

16. The oil drain apparatus as claimed in claim 15 further comprising a cap wherein said cap is removably attached to the threaded fitting of the second fitting.

17. The oil drain apparatus as claimed in claim 14 wherein the first threaded fitting of the first fitting screws into an oil pan of a vehicle.

18. The oil drain apparatus as claimed in claim 17 further comprising a washer;
the washer comprising an interior circumference and an outer circumference; and
the washer being positioned coaxially on the first threaded fitting of the first fitting, located between the oil pan and the hexagonal cross section.

19. An oil drain apparatus comprising:
a plurality of fittings comprising:
a first fitting; and
a second fitting
a plurality of sections of tubing;
a valve; and
a cap;
the plurality of sections of tubing comprising a first section of tubing and a second section of tubing;
the first section of tubing comprising a first end and a second end, wherein said first end and said second end are opposite distal ends of the first section of tubing;
the second section of tubing comprising a first end and a second end, wherein said first end and said second end are opposite distal ends of the second section of tubing;
the valve comprising a housing wherein said housing comprises an inlet port and an outlet port;
the first fitting connecting to the first end of the first section of tubing;
the second end of the first section of tubing connecting to the inlet port of the valve;
the outlet port of the valve being connected to the first end of the second section of tubing;
the second end of the second section of tubing being connected to the second fitting;
the first fitting comprising a first threaded fitting and a hexagonal cross section;
the first threaded fitting extends distally from the first end of the first section of tubing;
the first threaded fitting of the first fitting screwing into an oil pan of a vehicle;
the hexagonal cross section located adjacent to the first threaded fitting of the first fitting;
the second fitting comprising a threaded fitting wherein said threaded fitting extends distally from the second end of the second section of tubing; and
cap being removably attached to the threaded fitting of the second fitting.

20. The oil drain apparatus as claimed in claim 19 further comprising a washer;
the washer comprising an interior circumference and an outer circumference; and
the washer being positioned coaxially on the first threaded fitting of the first fitting, located between the oil pan and the hexagonal cross section.
